(19) United States
(12) Patent Application Publication
(10) Pub. No.: US 2007/0079345 A1
(43) Pub. Date: Apr. 5, 2007

(54) Television-based client device messaging

(75) Inventor: Elizabeth Rose McEnroe, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/241,806

(22) Filed: Sep. 30, 2005

(51) Int. Cl. H04N 7/16; H04N 7/173; H04N 11/00; H04N 7/00

(52) U.S. Cl. 725/106; 725/135; 725/133; 725/141; 348/552

(57) ABSTRACT

Television-based client device messaging is described. In an embodiment of television-based client device messaging, a system includes a television-based client device that is identified by an associated phone number to receive a message communicated from a messaging device via the associated phone number. A message parsing application parses the message received via the associated phone number, and generates a control command from the message that can be recognized by the television-based client device. Television-based client device messaging allows a user to conveniently access, control, send messages to, and receive messages from the television-based client device, regardless of whether the user is in the local environment or in a remote environment.

### BACKGROUND

During the past several years, television viewing habits have been rapidly changing in response to advances in technology, and to increased availability of viewing content. Television viewing is increasingly “on-demand” and the use of digital video recorders (DVRs) and other video on-demand playback systems have allowed many users to take greater control of their viewing schedules. Now, instead of watching programs at times scheduled by a provider of the programs, users are able to watch pre-recorded programs and/or on-demand programs at times convenient for the user.

Generally speaking, digital video recorders are electronic devices that record television programs to a hard disc and/or other data store in a digital format. Digital video recorders are commonly used to record television programs so that the recorded programs can be viewed at a later time. However, digital video recorders can also be used to pause “live television”, to replay interesting scenes, to skip advertising and/or to otherwise manipulate the recorded television program.

In most cases, a user can program a digital video recorder using a remote control, or by using selectable controls that are located on the digital video recorder itself. Once the digital video recorder has been programmed, and the user has left the local environment, the user is generally unable to access the digital video recorder to make programming changes. A few digital video recorder products allow remote access via a Web-page. In such cases, after the user accesses the Web-page, a server associated with the Web-page sends commands to the digital video recorder unit. Although such remote Web access can be useful to a user, in many cases access via a Web-page is inconvenient or unavailable.

### SUMMARY

This summary is provided to introduce simplified concepts of television-based client device messaging which is further described below in the Detailed Description. This summary is not intended to identify essential features of the claimed subject matter, nor is it intended for use in determining the scope of the claimed subject matter.

In an embodiment of television-based client device messaging, a television-based client device is identified by an associated phone number and can receive a message communicated from a messaging device via the associated phone number. A message parsing application parses the message received via the associated phone number, and generates a control command from the message that can be recognized by the television-based client device. Television-based client device messaging allows a user to conveniently access, control, send messages to, and receive messages from the television-based client device.

In another embodiment of television-based client device messaging, a television-based client device can generate a reply notice for communication to a messaging device to confirm receipt of a message, generate a conflict notice for communication to the messaging device when a recording conflict occurs, generate a recording notice for communication to the messaging device to identify a program that is scheduled to be recorded, and/or communicate other information about the television-based client device to the messaging device. Optionally, the television-based client device may be associated with more than one messaging device, such as each cell phone of each person that may schedule a recording via the television-based client device. The client device can then communicate any one or more of the updates, confirmations, and messages to any of the mobile messaging devices, such as a recording notice communicated only to the particular messaging device associated with the person that scheduled the recording.

### BRIEF DESCRIPTION OF THE DRAWINGS

The same numbers are used throughout the drawings to reference like features and components.

FIG. 1 illustrates an exemplary system in which embodiments of television-based client device messaging can be implemented.

FIG. 2 illustrates an exemplary method for television-based client device messaging.

FIG. 3 illustrates an exemplary method for television-based client device messaging.

FIG. 4 illustrates an exemplary system including various components of an exemplary television-based client device in which embodiments of television-based client device messaging can be implemented.

FIG. 5 illustrates various devices and components in an exemplary entertainment and information system in which embodiments of television-based client device messaging can be implemented.

### DETAILED DESCRIPTION

Television-based client device messaging provides that a television-based client device is identified by an associated phone number and can receive a message communicated from a messaging device via the associated phone number. The television-based client device includes a message parsing application that parses the message received via the associated phone number, and generates a control command from the message that can be recognized by the television-based client device. Television-based client device messaging allows a user to conveniently access, control, send messages/commands to, and receive messages from the television-based client device, regardless of whether the user is in the local environment (i.e., located proximate the television-based client device) or in a remote environment. In addition, the user is able to program the television-based client device without accessing a Web-page and/or the Web (World Wide Web).

While aspects of the described systems and methods for television-based client device messaging can be implemented in any number of different computing systems, environments, television-based entertainment systems, and/or configurations, embodiments of television-based client device messaging are described in the context of the following exemplary system architectures.

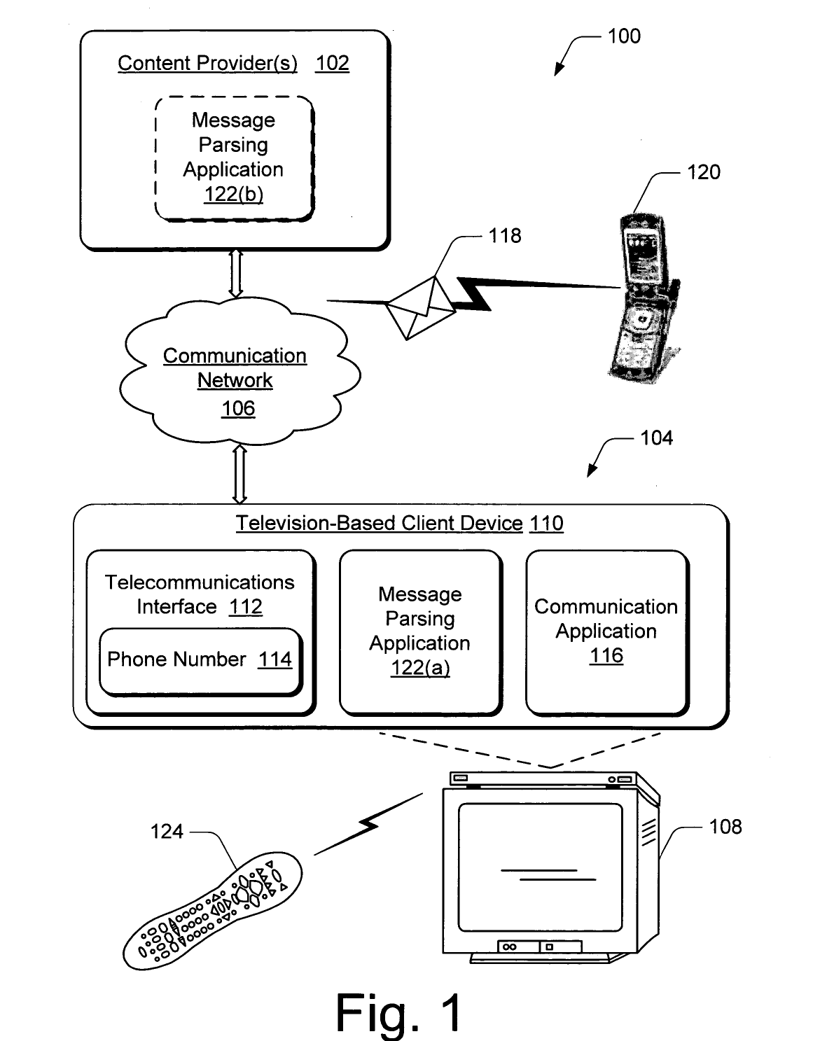

FIG. 1 illustrates an exemplary system 100 in which embodiments of television-based client device messaging can be implemented. In this example, system 100 includes one or more content providers 102, and a client system 104. The content providers 102 can be phone companies, cable companies, and/or any other type of content providers. The client system 104 is configured for communication with the content provider(s) 102 via a communication network 106. The client system 104 receives program content, various forms of media content, television programs, movies, program guide data, advertising content, and the like from content server(s) of the content providers 102 via the communication network 106, which in this example, is an IP-based network.

The client system 104 includes a display device 108 (e.g., a television, LCD display, and the like) and a television-based client device 110. The client device 110 can be implemented in any number of embodiments, such as a set-top box, a digital video recorder (DVR) and playback system, a personal video recorder (PVR), an appliance device, a gaming system, any combination thereof, and as any other type of client device that may be implemented in a television-based entertainment and information system.

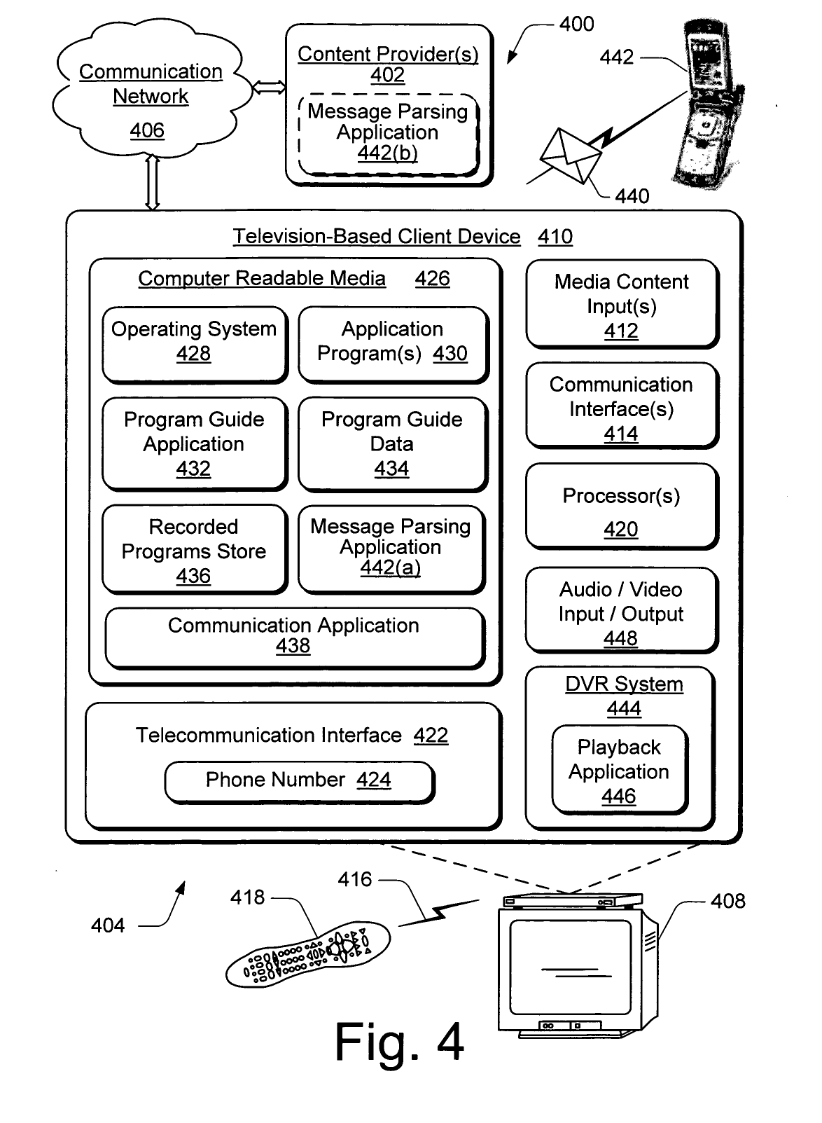

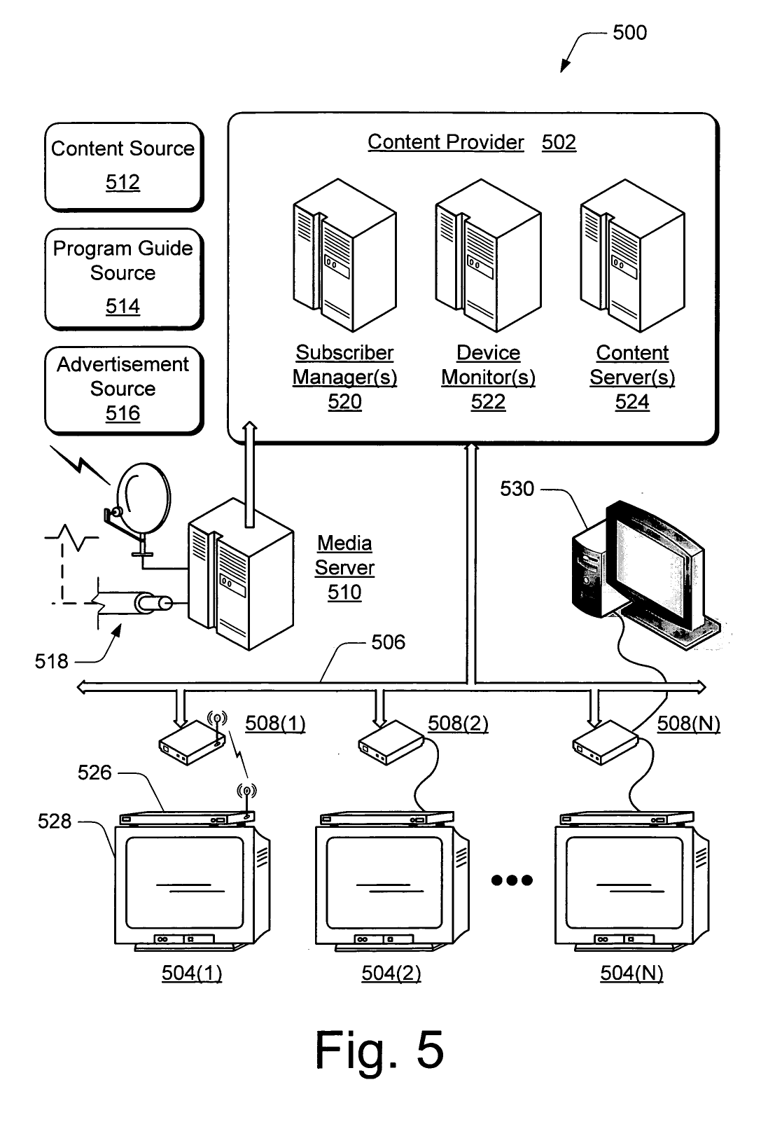

The television-based client device 110 can be connected to the display device 108, or it can be implemented as part of, or within the display device 108. In an embodiment, the client device 110 can be implemented with any one or combination of the components described with reference to client device 410 shown in FIG. 4. Further, any combination of the components described with reference to the system 100 can be implemented in the exemplary television-based system 500 that includes examples of both a network-based content provider and television-based client devices as described with reference to FIG. 5.

The television-based client device 110 includes a telecommunication interface 112 which is associated with a phone number 114. The associated phone number 114 identifies the television-based client device 110. The associated phone number can also be associated with other devices, such as one or more telephones (not shown). The phone number 114 can be associated with the local environment of the television-based client device 110. For example, if the television-base client device 110 is located in a user's home, the associated phone number 114 may be the user's “home phone number”, and the user's home telephone(s) may also be associated with the phone number 114.

The television-based client device 110 also includes a communication application 116 that is configured to receive a message 118 from a messaging device 120 via the associated phone number 114 that identifies the client device 110. The messaging device 120 can be a mobile phone, personal digital assistant (PDA), and/or any other type of suitable messaging device. In various embodiments, the messaging device 120 can communicate the message 118 to the television-based client device 110 directly, via the communication network 106, and/or via a content provider 102.

System 100 also includes a message parsing application 122. In one implementation, the television-based client device 110 includes the message parsing application as indicated by identifier 122(a). In such an implementation, the message parsing application 122(a) is configured to parse the message 118 received via the associated phone number 114, and to generate a control command from the message 118 that can be recognized by the television-based client device 110. In such an implementation, the message 118 is received by the client device 110 and is then acted upon.

In another implementation, a content provider 102 includes the message parsing application as indicated by identifier 122(b). In such an implementation, the content provider 102 can receive and parse the message 118, and can then send a data command (e.g., as a string of data packets that represent the parsed message) to the television-based client device 110 via the IP-based network 106.

In yet another implementation, the message parsing can be distributed throughout system 100. For example, some message parsing can take place at a content provider 102 (e.g., at message parsing application 122(b)), while other message parsing can take place at the television-based client device 110 (e.g., at message parsing application 122(a)).

A remote control device 124 or similar input device can be provided for controlling operation of the television-based client device 110 in the local environment, via a wireless interface. Thus, in the local environment, the user can use the remote control 124 and/or selectable controls (not shown) of the client device 110 to program the client device to record a program, to view a recorded program, to erase a program that has been previously recorded, to cause the client device 110 to display a recorded program, and/or to perform other operations.

With television-based client device messaging a user can use the messaging device 120 (e.g., mobile phone) to call the television-based client device 110 from a remote location or from the local environment. To call the television-based client device 110, the user can enter the associated telephone number 114 that identifies the television-based client device 110. The user can then send various messages 118 to television-based client device 110, thus allowing the user to program, control, and interface with the client device 110 from the remote location via the associated phone number 114. The different messages 118 entered by the user can include formatted commands, and can be parsed by the message parsing application 122 to generate different control commands that can be recognized by the television-based client device 110. The television-based client device 110 can be configured to respond to the different control commands in different ways. The television-based client device 110 can be configured to both send and receive notification and command messages.

For example, if the user is at a remote location, and decides to record a sports program that is scheduled to be shown on “Sports Channel Five” from 2:00-4:00 p.m. that afternoon, the user can simply use the messaging device 120 to communicate with the television-based client device 110 from the remote location using the associated phone number 114. The user can then enter a message 118 (e.g., a formatted command) that indicates that the television-based client device 110 is to record “Sports Channel Five” from 2:00-4:00 p.m. that afternoon. The message 118 is then communicated to the television-based client device 110 via the associated phone number 114. The message parsing application 122 then parses the message 118 to generate a control command that can be recognized by the television-based client device 110. The television-based client device 110 then acts on the control command by initiating a recording of “Sports Channel Five” at 2:00 p.m., and recording from 2:00-4:00 p.m. that afternoon.

In addition to initiating recordings in response to control commands received from a remote messaging device, the television-based client device 110 can be configured to communicate information about the television-based client device 110 to the messaging device 120. The television-based client device 110 can also be configured to generate replies and/or notices for communication to the messaging device 120. For example, the television-based client device 110 can be configured to generate a “reply notice” for communication to the messaging device 120 to confirm receipt of the message 118, to generate a “recording notice” for communication to the messaging device 120 to identify a program that is scheduled to be recorded, to generate a “finish recording notice” for communication to the messaging device 120 to indicate that a program recording has been completed, and/or to generate a “conflict notice” for communication to the messaging device 120 when a recording conflict occurs. The recording “conflict notice” sent to the messaging device 120 can include details regarding the recording conflict. For example, the “conflict notice” can indicate that there is not enough disc space available to record a selected program, or that multiple programs are scheduled to be recorded during the same time frame.

One can appreciate that television-based client device messaging allows the television-based client device 110 to both send and receive messages for a remote user. This allows the user to have constant control over the television-based client 110 device regardless of whether the user is near the television-based client device 110 or at some remote location.

In one exemplary implementation, the television-based client device 110 can be a digital video recorder and the messaging device 120 can be a mobile telephone. If a recording conflict occurs, the digital video recorder 110 can send a message to the mobile phone 120. For example, if two different television programs are scheduled to be recorded at the same time, the digital video recorder 110 can send a text message to the user's mobile phone 120. The text message might read, “Program A and Program B have both been scheduled to be recorded on Friday at 8:00 p.m. Only one television program can be recorded at a time. Please select which program you would like to recorded. Press “1” to record program A or press “2” to record program B.” It is also possible for the message sent from the digital video recorder 110 to the user's mobile phone 120 to include a Web browser option that allows the user to search scheduled television programming. The user could simply select which of the two programs to record, or use the Web browser option to search for other programming options. For example, one of the two programs might be re-broadcast at a later time, and the user may reprogram the digital video recorder 110 to record that program at the later time.

In another implementation the digital video recorder 110 can be programmed to send confirmation and/or recording notices to the user's mobile phone 120. The digital video recorder 110 can be programmed to send confirmations to the user's mobile phone 120 for all recorded programs, or to send confirmations for only certain recorded programs. For example, if a user wants to be sure that any televised broadcasts of a favorite sports team are not missed, the user can program the digital video recorder 110 to send a confirmation notice to the mobile phone before recording commences. By way of example, such a message might read: “Team A vs. Team B will be recorded today at 6:00-9:00 p.m. from the Sports Channel.” If the user does not receive the expected confirmation message before the sports event begins, the user can send a message 118 to the digital video recorder 110 to record the game.

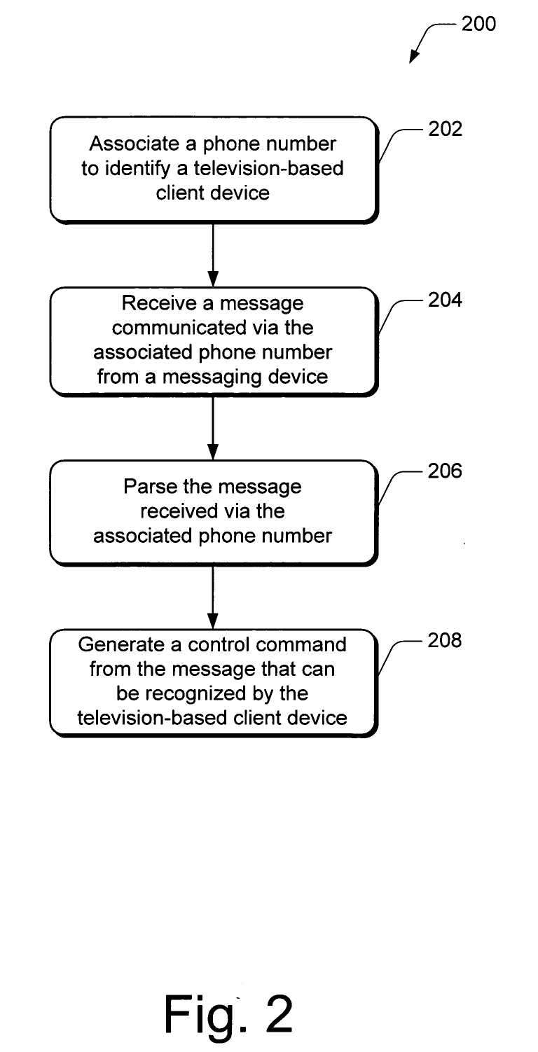

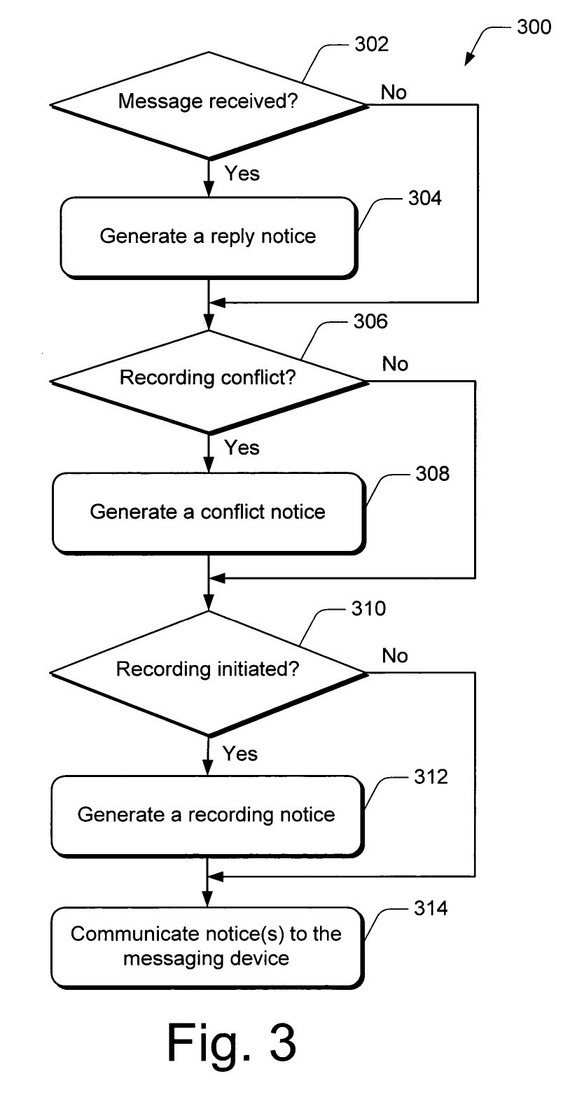

Methods for television-based client device messaging, such as exemplary methods 200 and 300 described with reference to respective FIGS. 2 and 3 may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 2 illustrates an exemplary method 200 for television-based client device messaging, and is described with reference to system 100 shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 202, a phone number is associated with a television-based client device to identify the client device. For example, phone number 114 is associated with television-based client device 110 to identify the client device 110.

At block 204, a message communicated via the associated phone number is received from the messaging device. For example, the message 118 is communicated from the messaging device 120 to the television-based client device 110 via the associated phone number 114.

At block 206, the message received via the associated phone number is parsed. For example, the message 118 received via the associated phone number 114 can be parsed by the message parsing application 122(a).

At block 208, a control command that can be recognized by the television-based client device is generated from the message. For example, a control command that can be recognized by the television-based client device 110 can be generated from the message 118.

FIG. 3 illustrates an exemplary method 300 for television-based client device messaging, and is described with reference to system 100 shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 302, a determination can be made as to whether a message has been received via the associated phone number. For example, a determination can be made as to whether a message 118 sent from the messaging device 120 (or any other messaging device) has been received by the television-based client device 110 via the associated phone number 114. If a message has not been received by the television-based client device 110 (i.e., no from block 302), then the method continues at block 306.

If a message has been received by the television-based client device 110. (i.e., yes from block 302), then a reply notice is generated at block 304. For example, if a message 118 has been received by the television-based client device 110, then a reply notice can be generated for communication to the messaging device 120 to confirm receipt of the message 118.

At block 306, a determination can be made as to whether a recording conflict is present. For example, a determination can be made as to whether multiple programs are scheduled to be recorded at the same time and/or whether enough disc space is available to record a selected program. If there is no recording conflict (i.e., no from block 306), then the method continues at block 310.

If a recording conflict is present (i.e., yes from block 306), then a recording conflict notice is generated at block 308. For example, if multiple programs are scheduled to be recorded at the same time and/or not enough disc space is available to record a selected program, a conflict notice can be generated for communication to the messaging device 120 to inform the user that a recording conflict has occurred, or is imminent.

At block 310, a determination can be made as to whether a recording has been initiated. For example, a determination can be made as to whether the television-based client device 110 has initiated recording a program. If a recording has not been initiated (i.e., no from block 310), then the method continues at block 314.

If a recording has been initiated by the television-based client device 110 (i.e., yes from block 310), then a recording notice is generated at block 312. For example, if a recording has been initiated by the television-based client device 110, then a recording notice can be generated for communication to the messaging device 120 identifying a program that is scheduled to be recorded, or that is being recorded as scheduled.

At block 314, the notices are communicated to the messaging device 120. For example, any one or more of the notices described above in blocks 304, 308, or 312 (i.e., the reply notice, conflict notice, and recording notice) can be communicated to the messaging device 120. Thus, the television-based client device 110 is configured to communicate information about the television-based client device 110 to the messaging device 120. Other information about the television-based client device 110 may include operational status, configuration status, storage capacity and availability, and/or any combination of other types of information that can be communicated to a user via the messaging device 120.

FIG. 4 illustrates an exemplary system 400 in which embodiments of television-based client device messaging can be implemented. The system 400 includes one or more content providers 402, and a client system 404. The content providers 402 can be phone companies, cable companies, and/or any other type of content providers. The client system 404 is configured for communication with the content provider(s) 402 via a communication network 406. The client system 404 receives program content, various forms of media content, television programs, movies, program guide data, advertising content, and the like from content server(s) of the content provider(s) 402 via the communication network 406, which in this example, is an IP-based network.

The client system 404 includes an audio rendering and/or display system 408 (e.g., a television, LCD display, and the like) and a television-based client device 410. In FIG. 4, the client device 410 is implemented as a digital video recorder (DVR) enabled client device in which embodiments of television-based client device messaging can be implemented. The client device 410 can be implemented as any one or more of the electronic, computing, and client devices described herein. For example, client device 410 can be implemented with any number of the various components as client device 110 in the client system 104 shown in FIG. 1.

Client device 410 includes one or more media content inputs 412 which may include Internet Protocol (IP) inputs over which streams of media content are received via an IP-based network (such as communication network 108 shown in FIG. 1). Device 410 further includes communication interface(s) 414 which can be implemented as any one or more of a serial and/or parallel interface, a wireless interface, any type of network interface, a modem, and as any other type of communication interface. A wireless interface enables device 410 to receive control input commands 416 and other information from an input device, such as from remote control device 418, a PDA (personal digital assistant), a cellular phone, or from another infrared (IR), 802.11, Bluetooth, or similar RF input device.

A network interface provides a connection between the client device 410 and a communication network by which other electronic and computing devices can communicate data with device 410. Similarly, a serial and/or parallel interface provides for data communication directly between device 410 and the other electronic or computing devices. A modem facilitates device 410 communication with other electronic and computing devices via a conventional telephone line, a DSL connection, cable, and/or other type of connection.

Client device 410 also includes one or more processors 420 (e.g., any of microprocessors, controllers, and the like) which process various computer executable instructions to control the operation of device 410, to communicate with other electronic and computing devices, and to implement embodiments of automatic content presentation.

The client device 410 also includes a telecommunication interface 422 which is associated with a phone number 424. The phone number 424 may also be associated with client device 410 by utilizing a component external to the client device, such as a residential gateway or DSL modem. The associated phone number 424 identifies the television-based client device 410 for television-based client device messaging. The associated phone number 424 can also be associated with other devices, such as one or more telephones (not shown).

Device 410 can be implemented with computer readable media 426, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 426 provides data storage mechanisms to store various information and/or data such as software applications and any other types of information and data related to operational aspects of the client device 410. For example, an operating system 428 and/or other application programs 430 can be maintained as software applications with the computer readable media 426 and executed on processor(s) 420 to implement embodiments television-based client device messaging. Further, the computer readable media 426 includes a program guide application 432 that is implemented to process program guide data 434 and generate program guides for display which enable a viewer to navigate through an onscreen display and locate broadcast programs, recorded programs, video on-demand programs and movies, interactive game selections, and other media access information or content of interest to the viewer. Still further, the computer readable media 426 includes a recorded programs application (not shown) that can be incorporated into the program guide application 432 and/or incorporated into one or more of the other application programs 430. The computer readable media 426 also includes a recorded programs store 436 to maintain recorded television programs, movies, and/or other recorded content.

Still further, the television-based client device 410 includes a communication application 438 that is configured to receive a message 440 from a messaging device 442 via the associated phone number 424 that identifies the client device 410. The messaging device 442 can be a mobile phone, personal digital assistant (PDA), and/or any other type of suitable messaging device. As described above, the messaging device 442 can communicate the message 440 to the television-based client device 410 directly, via the communication network 406, and/or via a content provider 402.

System 400 also includes a message parsing application 442. In one implementation, the television-based client device 410 includes the message parsing application as indicated by identifier 442(a). In such an implementation, the message parsing application 442(a) is configured to parse the message 440 received via the associated phone number 424, and to generate a control command from the message 440 that can be recognized by the television-based client device 410. In such an implementation, the message 440 is received by the client device 410 and is then acted upon. Alternatively, the message 440 can be received and parsed in a home where the client device 410 is located with a component external to the client device, such as a residential gateway or DSL modem.

In another implementation, a content provider 402 (e.g., the phone company, cable company, and/or other content provider) includes the message parsing application as indicated by identifier 442(b). In such an implementation, the content provider 402 can receive and parse the message 440, and can then send a data command that represents the parsed message to the television-based client device 410 via the IP network 406.

In another implementation, the message parsing can be distributed throughout system 400. For example, some message parsing can take place at the content provider(s) 402 (e.g., at message parsing application 442(b)), while other message parsing can take place at the television-based client device 410 (e.g., at message parsing application 442(a)).

The client device 410 can also include a DVR system 444 with playback application 446. The DVR system 444, along with the playback application 446, can implement the various features and aspects of television-based client device messaging, such as described in methods 200 and 300 described with reference to FIGS. 2 and 3.

The client device 410 also includes an audio and/or video output 448 that provides audio and video to the display and/or audio rendering system 408, or to other devices that process, display, and/or otherwise render audio, video, and display data. Video signals and audio signals can be communicated from device 410 to the system 408 via an RF (radio frequency) link, S-video link, composite video link, component video link, analog audio connection, or other similar communication link.

FIG. 5 illustrates an exemplary entertainment and information system 500 in which an IP-based television environment can be implemented, and in which embodiments of television-based client device messaging can be implemented. System 500 facilitates the distribution of program content, program guide data, and advertising content to multiple viewers. System 500 includes a content provider 502 and television-based client systems 504(1−N) each configured for communication via an IP-based network 506.

The network 506 can be implemented as a wide area network (e.g., the Internet), an intranet, a Digital Subscriber Line (DSL) network infrastructure, or as a point-to-point coupling infrastructure. Additionally, network 506 can be implemented using any type of network topology and any network communication protocol, and can be represented or otherwise implemented as a combination of two or more networks. A digital network can include various hardwired and/or wireless links 508(1−N), routers, gateways, and so on to facilitate communication between content provider 502 and the client systems 504(1−N). The television-based client systems 504(1−N) receive program content, program guide data, advertising content, closed captions data, and the like from content server(s) of the content provider 502 via the IP-based network 506.

System 500 includes a media server 510 that receives program content from a content source 512, program guide data from a program guide source 514, and advertising content from an advertisement source 516. In an embodiment, the media server 510 represents an acquisition server that receives the audio and video program content from content source 512, an EPG server that receives the program guide data from program guide source 514, and/or an advertising management server that receives the advertising content from the advertisement source 516.

The content source 512, the program guide source 514, and the advertisement source 516 control distribution of the program content, the program guide data, and the advertising content to the media server 510 and/or to other television-based servers. The program content, program guide data, and advertising content is distributed via various transmission media 518, such as satellite transmission, radio frequency transmission, cable transmission, and/or via any number of other transmission media. In this example, media server 510 is shown as an independent component of system 500 that communicates the program content, program guide data, and advertising content to content provider 502. In an alternate implementation, media server 510 can be implemented as a component of content provider 502.

Content provider 502 is representative of a headend service in a television-based content distribution system, for example, that provides the program content, program guide data, and advertising content to multiple subscribers (e.g., the television-based client systems 504(1−N)). The content provider 502 can be implemented as a satellite operator, a network television operator, a cable operator, and the like to control distribution of program and advertising content, such as movies, television programs, commercials, music, and other audio, video, and/or image content to the client systems 504(1−N).

Content provider 502 includes various components to facilitate media data processing and content distribution, such as a subscriber manager 520, a device monitor 522, and a content server 524. The subscriber manager 520 manages subscriber data, and the device monitor 522 monitors the client systems 504(1−N) (e.g., and the subscribers), and maintains monitored client state information.

Although the various managers, servers, and monitors of content provider 502 (to include the media server 510 in one embodiment) are illustrated and described as distributed, independent components of content provider 502, any one or more of the managers, servers, and monitors can be implemented together as a multi-functional component of content provider 502. Additionally, any one or more of the managers, servers, and monitors described with reference to system 500 can implement features and embodiments of television-based client device messaging.

The television-based client systems 504(1−N) can be implemented to include a client device 526 and a display device 528 (e.g., a television). A client device 526 of a television-based client system 504 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 504(N) is implemented with a computing device 530 as well as a client device 526. Additionally, any of the client devices 526 of a client system 504 can implement features and embodiments of television-based client device messaging as described herein.

Although embodiments of television-based client device messaging have been described in language specific to structural features and/or methods, it is to be understood that the subject of the appended claims is not necessarily limited to the specific features or methods described. Rather, the specific features and methods are disclosed as exemplary implementations of television-based client device messaging.

1. A system, comprising:
a television-based client device identified by an associated phone number and configured to receive a message communicated from a messaging device via the associated phone number; and
a message parsing application configured to parse the message received via the associated phone number, and further configured to generate a control command from the message that can be recognized by the television-based client device.

2. The system of claim 1, wherein the television-based client device is further configured to initiate a recording in response to the control command.

3. The system of claim 1, wherein the television-based client device is further configured to generate a reply notice for communication to the messaging device to confirm receipt of the message.

4. The system of claim 1, wherein the television-based client device is further configured to generate a conflict notice for communication to the messaging device when a recording conflict occurs.

5. The system of claim 1, wherein the television-based client device is further configured to generate a recording notice for communication to the messaging device to identify a program that is scheduled to be recorded.

6. The system of claim 1, wherein the messaging device is a mobile phone, and wherein the television-based client device is further configured to communicate information about the television-based client device to the mobile phone.

7. The system of claim 1, wherein the television-based client device is a digital video recorder that is configured to initiate a recording in response to the control command.

8. The system of claim 1, wherein the associated phone number is associated with a telecommunications interface of the television-based client device, and wherein the messaging device is a mobile phone.

9. A television-based client device, comprising:
a communication application configured to receive a message from a messaging device, the message communicated via an associated phone number that identifies the television-based client device; and
a message parsing application configured to parse the message received via the associated phone number, and further configured to generate a control command from the message that can be recognized by the television-based client device.

10. The television-based client device of claim 9, further comprising a digital video recording system configured to initiate a recording in response to the control command.

11. The television-based client device of claim 9, wherein the communication application is further configured to generate a reply notice for communication to the messaging device to confirm receipt of the message.

12. The television-based client device of claim 9, wherein the communication application is further configured to generate a conflict notice for communication to the messaging device when a recording conflict occurs.

13. The television-based client device of claim 9, wherein the communication application is further configured to generate a recording notice for communication to the messaging device identifying a television program that is scheduled to be recorded.

14. The television-based client device of claim 9, wherein the messaging device is a mobile phone, and wherein the communication application is further configured to communicate information about the television-based client device to the mobile phone.

15. The television-based client device of claim 9, wherein the television-based client device is a digital video recorder, the associated phone number is associated with a telecommunication interface of the digital video recorder, and wherein the messaging device is a mobile phone.

16. A method comprising:
associating a phone number to identify a television-based client device;
receiving a message communicated via the associated phone number from a messaging device;
parsing the message received via the associated phone number; and
generating a control command from the message that can be recognized by the television-based client device.

17. The method of claim 16, further comprising recording a program in response to the control command.

18. The method of claim 16, further comprising generating a reply notice for communication to the messaging device confirming receipt of the message.

19. The method of claim 16, further comprising generating a conflict notice for communication to the messaging device when a recording conflict occurs.

20. The method of claim 16, further comprising generating a recording notice for communication to the messaging device identifying a program that is scheduled to be recorded.
